(19) United States
(12) Patent Application Publication
(10) Pub. No.: US 2025/0296339 A1
(43) Pub. Date: Sep. 25, 2025

(54) PRINTING APPARATUS AND RECORDING HEAD CLEANING METHOD

(71) Applicant: SCREEN Holdings Co., Ltd., Kyoto (JP)

(72) Inventors: Hiroyuki KAJIYA, Kyoto-shi (JP); Takaharu YAMAMOTO, Kyoto-shi (JP)

(21) Appl. No.: 19/045,625

(22) Filed: Feb. 5, 2025

(30) Foreign Application Priority Data
Mar. 25, 2024 (JP) 2024-048167

(51) Int. Cl. B41J 2/165

(52) U.S. Cl. CPC B41J 2/16511; B41J 2002/16594; B41P 2235/26; B41P 2235/27

(57) ABSTRACT

The maintenance member has the discharge plane, which is adjacent to the cleaning plane in the cleaning direction and recessed downward from the cleaning plane. This discharge plane is provided between the two extended surfaces, which are extended in the cleaning direction respectively from the two contact planes, in the X direction. In such a configuration, a flow of the cleaning liquid falling down from the cleaning plane to the discharge plane in the cleaning direction is formed. Thus, the amount of the cleaning liquid flowing in the X direction from the cleaning plane can be suppressed.

### CROSS REFERENCE TO RELATED APPLICATION

The disclosure of Japanese Patent Application No. 2024-048167 filed on Mar. 25, 2024 including specification, drawings and claims is incorporated herein by reference in its entirety.

### BACKGROUND

### Technical Field

This disclosure relates to a technique for cleaning a recording head for discharging an ink from an ink nozzle.

### Background Art

An inkjet recording head has a nozzle surface, in which ink nozzles for discharging an ink are open. In such a recording head, part of the ink discharged from the ink nozzles adheres the nozzle surface to contaminate the nozzle surface. Accordingly, in JP7006705, the ink is removed from the nozzle surface. Specifically, a suction member including suction holes sucks the ink from the nozzle surface to the suction holes, whereby the ink is removed from the nozzle surface.

### SUMMARY

A cleaning liquid can be used to wash away the ink adhering to the recording head. However, the cleaning liquid may spread in an improper direction, whereby the recording head may be contaminated with the ink contained in the cleaning liquid. That is, in cleaning the nozzle surface by supplying the cleaning liquid from a maintenance member, the contact of a maintenance unit with the nozzle surface needs to be avoided to prevent the breakage of the nozzle surface. Accordingly, it is, for example, thought to provide head contact surfaces on both sides in a width direction of the nozzle surface and supply the cleaning liquid to the nozzle surface from the maintenance member while bringing the maintenance member into contact with the head contact surfaces. However, the cleaning liquid containing the ink washed away from the nozzle surface may spread in the width direction and the head contact surfaces may be contaminated with the ink.

This disclosure was developed in view of the above problem and aims to enable the adhesion of an ink to head contact surfaces on both sides of a nozzle surface of a recording head to be suppressed in cleaning the nozzle surface with the cleaning liquid.

A printing apparatus according to the disclosure, comprises: a recording head having a nozzle surface, an ink nozzle for discharging an ink being open in the nozzle surface, and two head contact surfaces provided on both sides in a width direction of the nozzle surface and located below the nozzle surface; a maintenance member having a cleaning surface, a cleaning liquid nozzle for discharging a cleaning liquid being open in the cleaning surface, and two maintenance contact surfaces provided on both sides in the width direction of the cleaning surface; a driver configured to perform a moving operation of relatively moving the maintenance member with respect to the recording head in a moving direction orthogonal to the width direction with the maintenance member caused to face the recording head from below and the two maintenance contact surfaces respectively held in contact with the two head contact surfaces; and a cleaning liquid supplier configured to perform a cleaning liquid supplying operation of supplying the cleaning liquid to the cleaning surface from the cleaning liquid nozzle by causing the cleaning liquid nozzle to discharge the cleaning liquid, the cleaning liquid supplier performing the cleaning liquid supplying operation in parallel with the moving operation by the driver, the maintenance member having a discharge surface, which is adjacent to the cleaning surface in the moving direction and recessed downward from the cleaning surface, and two extended surfaces, which are extended further toward the discharge surface than the cleaning surface respectively from the two maintenance contact surfaces in the moving direction, and the discharge surface being located between the two extended surfaces in the width direction.

A recording head cleaning method according to the disclosure, comprises: performing a moving operation of relatively moving a maintenance member with respect to a recording head in a moving direction with the maintenance member held in contact with the recording head from below; and performing a cleaning liquid supplying operation of supplying a cleaning liquid to between the maintenance member and the recording head, the recording head having a nozzle surface, an ink nozzle for discharging an ink being open in the nozzle surface, and two head contact surfaces provided on both sides of the nozzle surface in a width direction orthogonal to the moving direction and located below the nozzle surface, the maintenance member having a cleaning surface, a cleaning liquid nozzle for discharging a cleaning liquid being open in the cleaning surface, and two maintenance contact surfaces provided on both sides in the width direction of the cleaning surface; the maintenance member being relatively moved with respect to the recording head in the moving direction with the maintenance member facing the recording head from below and the two maintenance contact surfaces respectively held in contact with the two head contact surfaces in the moving operation, the cleaning liquid being supplied from the cleaning liquid nozzle to the cleaning surface by the cleaning liquid nozzle discharging the cleaning liquid in the cleaning liquid supplying operation, the maintenance member having a discharge surface adjacent to the cleaning surface in the moving direction and recessed downward from the cleaning surface and two extended surfaces extended further toward the discharge surface than the cleaning surface respectively from the two maintenance contact surfaces in the moving direction, and the discharge surface being located between the two extended surfaces in the width direction.

According to the disclosure (printing apparatus and recording head cleaning method) thus configured, the maintenance member has the cleaning surface, the cleaning liquid nozzle for discharging the cleaning liquid being open in the cleaning surface, and the two maintenance contact surfaces provided on the both sides in the width direction of the cleaning surface. The cleaning liquid is supplied to the cleaning surface from the cleaning liquid nozzle by the cleaning liquid nozzle discharging the cleaning liquid (cleaning liquid supplying operation) while the maintenance member is relatively moved with respect to the recording head in the moving direction with the maintenance contact surfaces on the both sides of the cleaning surface held in contact with the head contact surfaces on the both sides of the nozzle surface (moving operation). In contrast, the maintenance member has the discharge surface adjacent to the cleaning surface in the moving direction and recessed downward from the cleaning surface. This discharge surface is provided between the two extended surfaces, which are extended in the moving direction respectively from the two maintenance contact surfaces, in the width direction. In such a configuration, a flow of the cleaning liquid falling down from the cleaning surface to the discharge surface in the moving direction is formed. Thus, the amount of the cleaning liquid flowing in the width direction from the cleaning surface can be suppressed. As a result, it is possible to suppress the adhesion of the ink to the head contact surfaces on the both sides of the nozzle surface of the recording head in cleaning the nozzle surface by the cleaning liquid.

As described above, according to the disclosure, it is possible to suppress the adhesion of an ink to head contact surfaces on both sides of a nozzle surface of a recording head in cleaning the nozzle surface with the cleaning liquid.

The above and further objects and novel features of the disclosure will more fully appear from the following detailed description when the same is read in connection with the accompanying drawing. It is to be expressly understood, however, that the drawing is for purpose of illustration only and is not intended as a definition of the limits of the disclosure.

### BRIEF DESCRIPTION OF THE DRAWINGS

FIG. 1 is a front view schematically showing a printing apparatus according to the disclosure.

FIG. 2 is a bottom view schematically showing the bottom surfaces of the recording heads provided in the head unit.

FIG. 3A is a perspective view showing an example of the maintenance unit.

FIG. 3B is a perspective view showing an example of a maintenance member included in the maintenance unit of FIG. 3A.

FIG. 3C is a partial sectional view schematically showing a positional relationship of the maintenance member of FIG. 3B and the recording head.

FIG. 4 shows diagrams schematically showing a recording head cleaning operation performed by the maintenance member.

FIG. 5 is a block diagram showing an electrical configuration for performing the cleaning operation of FIG. 4.

FIG. 6 is a bottom view schematically showing a positional relationship of the ink nozzles Hn and the suction nozzles Ns.

FIG. 7 is a diagram showing a modification of the positional relationship of the cleaning plane and the contact plane.

FIG. 8 is a diagram schematically showing a modification of the arrangement mode of the suction nozzles.

### DETAILED DESCRIPTION

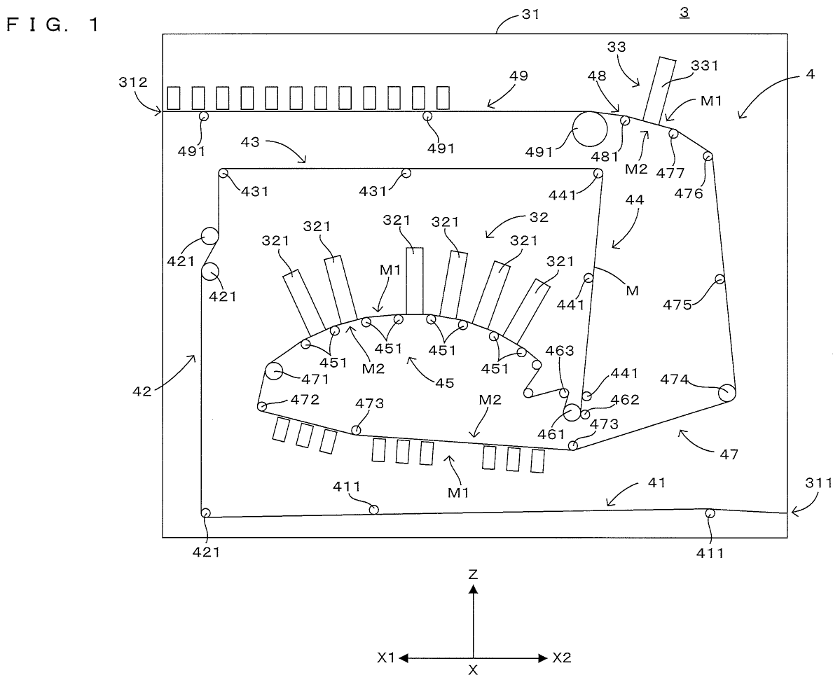

FIG. 1 is a front view schematically showing a printing apparatus according to the disclosure. In FIG. 1, an X direction, which is a horizontal direction, and a Z direction, which is a vertical direction, are shown. Further, one side X1 and another side X2 in the X direction opposite to each other are shown. A printing apparatus 3 is provided with a housing 31, a color printer 32 arranged in the housing 31, a white printer 33 arranged above the color printer 32 in the housing 31 and a conveyor 4 for conveying a printing medium M by a plurality of rollers arranged in the housing 31.

The color printer 32 includes a plurality of (six) head units 321 arrayed in a moving direction (direction from the other side X2 to the one side X1) of the printing medium M above the printing medium M being conveyed by the conveyor 4. The plurality of head units 321 include nozzles facing a front surface M1 of the printing medium M passing therebelow from above and discharge color inks of mutually different colors in an inkjet method. Here, the color inks mean inks other than a white ink and include inks of cyan, magenta, yellow, black and the like. In this way, the plurality of head units 321 of the color printer 32 print a color image on the front surface M1 of the printing medium M by discharging the color inks to the front surface M1 of the printing medium M passing therebelow from above.

Further, the white printer 33 includes a single head unit 331 arranged above the printing medium M being conveyed by the conveyor 4. The head unit 331 includes nozzles facing the front surface M1 of the printing medium M passing therebelow from above and discharges the white ink from the nozzles in the inkjet method. In this way, the head unit 331 of the white printer 33 prints a white image on the front surface M1 of the printing medium M by discharging the white ink to the front surface M1 of the printing medium M passing therebelow from above.

A carry-in port 311 is open in a side wall on the other side X2 of the housing 31, whereas a carry-out port 312 is open in a side wall on the one side X1 of the housing 31. The conveyor 4 conveys the printing medium M from the carry-in port 311 to the carry-out port 312 by way of the above color printer 32 and white printer 33.

This conveyor 4 includes a carry-in part 41 provided below the color printer 32, an ascending conveyor 42 provided on the one side X1 of the color printer 32, an upper conveyor 43 provided above the color printer 32 and a descending conveyor 44 provided on the other side X2 of the color printer 32. The carry-in part 41 conveys the printing medium M carried in through the carry-in port 311 toward the one side X1 by rollers 411, the ascending conveyor 42 conveys the printing medium M conveyed by the carry-in part 41 upward by rollers 421, the upper conveyor 43 conveys the printing medium M conveyed by the ascending conveyor 42 toward the other side X2 by rollers 431 and the descending conveyor 44 conveys the printing medium M conveyed by the upper conveyor 43 downward by rollers 441.

Further, the conveyor 4 includes a color conveyor 45 for supporting the printing medium M facing the color printer 32 from below. The printing medium M passed through the descending conveyor 44 enters the color conveyor 45. This color conveyor 45 includes a plurality of rollers 451 arrayed from the other side X2 toward the one side X1 and each roller 451 contacts an back surface M2 of the printing medium M from below. In this way, the front surface M1 of the printing medium M supported by the color conveyor 45 faces upward and each head unit 321 of the color printer 32 discharges the color ink while facing this top surface M from above.

Further, the conveyor 4 includes rollers 461, 462 and 463 arranged between the color conveyor 45 and the descending conveyor 44 in the moving direction of the printing medium M. The roller 461 is a drive roller for driving the printing medium M. The rollers 462, 463 are driven rollers configured to rotate, following the printing medium M.

Further, the conveyor 4 includes an inverting conveyor 47 for vertically inverting the printing medium M conveyed to the one side X1 from color conveyor 45 twice. This inverting conveyor 47 includes a plurality of rollers 471 to 477 including the drive roller 471, and these rollers 471 to 477 vertically invert the printing medium M twice while contacting the back surface M2 of the printing medium M. That is, the inverting conveyor 47 vertically inverts the front surface M1 and the back surface M2 of the printing medium M by conveying the printing medium M conveyed from the color conveyor 45 downward by the rollers 471, 472 and further changing and conveying the moving direction of the printing medium M toward the other side X2 by the roller 472. Subsequently, the inverting conveyor 47 conveys the printing medium M from the one side X1 toward the other side X2 by a plurality of the rollers 473 and, then, conveys the printing medium M upward by the rollers 474 to 476. Further, the inverting conveyor 47 vertically inverts the front surface M1 and the back surface M2 of the printing medium M again by changing the moving direction of the printing medium M toward the one side X12 by the roller 476, and conveys the printing medium M from the other side X2 toward the one side X1 by the roller 477.

Further, the conveyor 4 includes a white conveyor 48 for supporting the printing medium M facing the white printer 33 from below, and the printing medium M vertically inverted twice by the inverting conveyor 47 enters the white conveyor 48. This white conveyor 48 includes a roller 481 contacting the back surface M2 of the printing medium M from below. In this way, the front surface M1 of the printing medium M supported by the white conveyor 48 faces upward, and the head unit 331 of the white printer 33 discharges the white ink while facing the front surface M1 from above.

Further, the conveyor 4 includes a carry-out part 49 provided above the upper conveyor 43. The carry-out part 49 includes a plurality of rollers 491 arrayed from the other side X2 to the one side X1 in the X direction. This carry-out part 49 carries out the printing medium M through the carry-out port 312 of the housing 31 by conveying the printing medium M, conveyed by the white conveyor 48, toward the one side X1 by the plurality of rollers 491.

As described above, the color printer 32 and the white printer 33 of the printing apparatus 3 include the head units 321, 331. Next, recording heads H of the head units 321, 331 are described. Note that a basic configuration of the recording head H is common to each of the head unit 331 for discharging the white ink and the head units 321 for discharging the color inks. Thus, a configuration for the head unit 331 for discharging the white ink is described here.

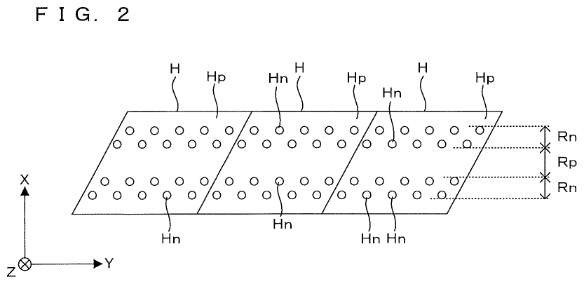

FIG. 2 is a bottom view schematically showing the bottom surfaces of the recording heads provided in the head unit. In FIG. 2, a Y direction, which is a horizontal direction orthogonal to the X direction, is shown besides the aforementioned X direction and Z direction. In the bottom surface of the head unit 331, a plurality of the recording heads H are arrayed in a row in the Y direction. Each recording head H has a parallelogram shape defined by two sides parallel to the Y direction and two sides inclined from the X direction. Note that the shape of the recording head H is not limited to an example of FIG. 2 and may be, for example, a rectangular shape. Each recording head H includes a nozzle opening plane Hp facing downward in the Z direction and ink nozzles Hn open downward in the nozzle opening plane Hp. This nozzle opening plane Hp is, for example, made of silicon. In the nozzle opening plane Hp, a nozzle non-arrangement region Rp located at a center in the X direction and two nozzle arrangement regions Rn located on both sides in the X direction of the nozzle non-arrangement region Rp are provided. Each of the nozzle non-arrangement region Rp and the nozzle arrangement regions Rn is provided in parallel to the Y direction. In the nozzle arrangement region Rn, a plurality of the ink nozzles Hn are arrayed at predetermined intervals in the Y direction. On the other hand, no ink nozzles Hn are provided in the nozzle non-arrangement region Rp. The recording head H discharges the ink downward from the ink nozzles Hn open in the nozzle arrangement regions Rn in an inkjet method.

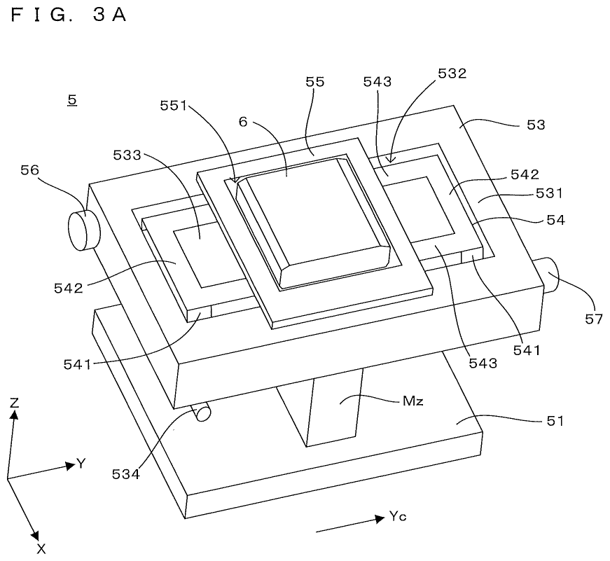

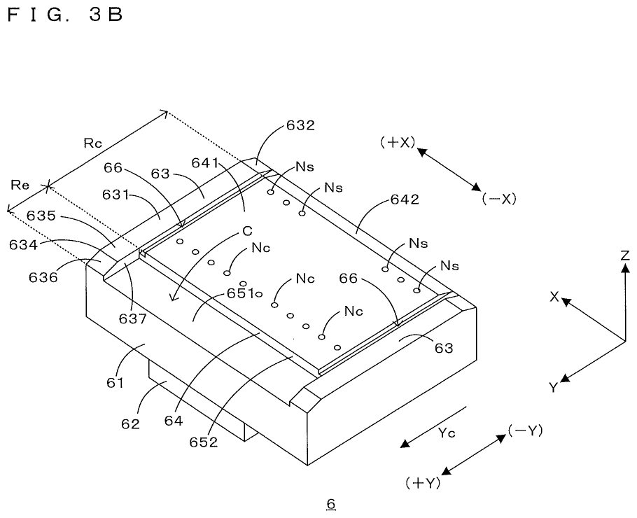

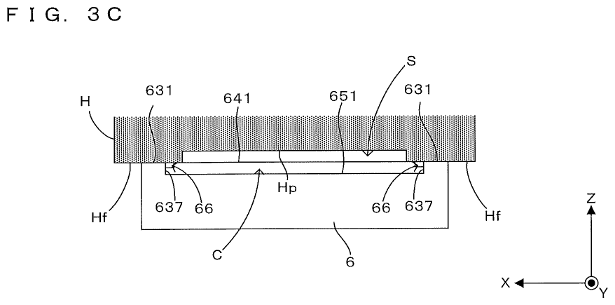

The ink discharged from the ink nozzles Hn adheres to the nozzle opening plane Hp of the recording head H. Accordingly, the printing apparatus 3 is provided with a maintenance unit 5 (FIGS. 3A and 3B) configured to remove the ink from the nozzle opening plane Hp.

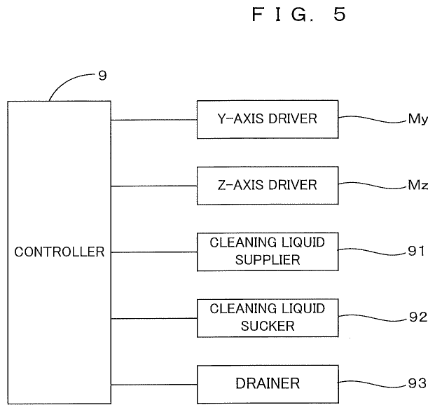

FIG. 3A is a perspective view showing an example of the maintenance unit, FIG. 3B is a perspective view showing an example of a maintenance member included in the maintenance unit of FIG. 3A and FIG. 3C is a partial sectional view schematically showing a positional relationship of the maintenance member of FIG. 3B and the recording head. The maintenance unit 5 is movable in a cleaning direction Yc parallel to the Y direction by receiving a drive force of a Y-axis driver My (FIG. 5) to be described later. Note that the maintenance unit 5 may be mounted while being slightly inclined according to the posture of the corresponding head unit 321, 331. However, the inclinations of the maintenance unit 5 with respect to the X direction, the Y direction and the Z direction are assumed to be tiny and ignored here.

As shown in FIG. 3A, the maintenance unit 5 includes a base plate 51, a Z-axis driver Mz mounted on the upper surface of the base plate 51 and a drainage tray 53 supported movably upward and downward by the Z-axis driver Mz, and the Z-axis driver Mz moves the drainage tray 53 upward and downward with respect to the base plate 51. The Z-axis driver Mz is, for example, an air cylinder.

The drainage tray 53 includes a tray body 531, and a recess 532 open upward is provided in the tray body 531. The tray body 531 and the recess 532 have a rectangular shape extending in the Y direction in a plan view from the Z direction. The drainage tray 53 receives a cleaning liquid falling down from the maintenance member 6, which faces the recess 532 of the drainage tray 53 from above, by a bottom surface 533 of the recess 532. A drainage port 534 is provided for the bottom surface 533 of the drainage tray 53, and the cleaning liquid received by the bottom surface 533 is discharged to outside from the drainage port 534.

A leaf spring member 54 made of metal and extending in the Y direction is placed on the bottom surface 533 of the recess 532. The leaf spring member 54 includes four legs 541 respectively provided on four corners, and each leg 541 rises upward in the Z direction from the bottom surface 533 of the recess 532. Further, the leaf spring member 54 includes two frames 542 respectively extending in the X direction. Out of the two frames 542, the frame 542 on one side in the Y direction connects the upper ends of two legs 541 located on one end in the Y direction, and the frame 542 on the other side in the Y direction connects the upper ends of two legs 541 located on the other end in the Y direction. The frame 542 has a flat plate shape. Further, the leaf spring member 54 includes two frames 543 respectively extending in the Y direction. Out of the two frames 543, the frame 543 on one side in the X direction connects the upper ends of two legs 541 located on one end in the X direction, and the frame 543 on the other side in the X direction connects the upper ends of two legs 541 located on the other end in the X direction. The frame 543 has a flat plate shape and is longer than the frame 542. Central parts in the Y direction of these frames 543 are vertically deflected, thereby exhibiting a function as a leaf spring.

The maintenance member 6 is arranged on the two frames 543 of the leaf spring member 54. That is, the maintenance member 6 is placed across the two frames 543 in the X direction and located in a center of each frame 543 in the Y direction. In this way, the maintenance member 6 is supported movably upward and downward in the Z direction by the leaf spring member 54.

Further, the maintenance unit 5 includes a frame body 55 mounted on the upper surface of the tray body 531 of the drainage tray 53. This frame body 55 surrounds the maintenance member 6 in the X direction and the Y direction. That is, the frame body 55 includes an opening 551 penetrating in the Z direction, and the maintenance member 6 is located inside the opening 551.

Further, the maintenance unit 5 includes a cleaning liquid supply port 56 for supplying the cleaning liquid to the maintenance member 6 and a cleaning liquid suction port 57 for sucking the cleaning liquid from the maintenance member 6. The cleaning liquid supply port 56 is connected to later-described cleaning liquid nozzles Nc by pipes, and the cleaning liquid suction port 57 is connected to later-described suction nozzles Ns by pipes.

The maintenance member 6 is described using FIG. 3B. Note that a (+X) side and a (−X) side opposite to each other in the X direction and a (+Y) side and a (−Y) side opposite to each other in the Y direction are shown in FIG. 3B. The (+Y) side corresponds to a downstream side in the cleaning direction Yc, and (−Y) side corresponds to an upstream side in the cleaning direction Yc.

The maintenance member 6 includes a base part 61 having a rectangular parallelepiped shape and a spring mounting part 62 projecting downward from the base part 61. The spring mounting part 62 is fastened to each of the two frames 543 of the leaf spring member 54, for example, by screws.

Further, the maintenance member 6 includes a pair of side wall parts 63 which project upward from the upper surface of the base part 61 on both ends in the X direction. The side wall part 63 has a rectangular shape defined by sides parallel to the X direction or the Y direction in a plan view and extends in the Y direction. Further, the maintenance member 6 includes a stage 64 which projects from the upper surface of the base part 61 between the pair of side wall parts 63 in the Y direction. The stage 64 has a rectangular shape defined by sides parallel to the X direction or the Y direction in a plan view and extends in the X direction. In the Y direction, the position of an end on the (−Y) side of the stage 64 and the position of an end on the (−Y) side of each side wall part 63 coincide (in other words, these ends are arranged in the X direction).

A cleaning plane 641 is provided on the upper surface of the stage 64. The cleaning liquid nozzles Nc and the suction nozzles Ns are open in the cleaning plane 641. Specifically, a plurality of the cleaning liquid nozzles Nc are open further on the (+Y) side than the center of the cleaning plane 641 in the Y direction. The plurality of cleaning liquid nozzles Nc are arrayed in a row in the X direction. Further, a plurality of the suction nozzles Ns are open further on the (−Y) side than the center of the cleaning plane 641 in the Y direction. The plurality of suction nozzles Ns are arrayed in a row in the X direction. However, in the X direction, the suction nozzles Ns are provided in both end parts of the cleaning plane 641, but not provided in a central part. This is not to cause the suction nozzles Ns to face the nozzle arrangement region Rn when the maintenance member 6 faces the recording head H from below.

Further, a tapered surface 642 is provided on the upper surface of the stage 64. The tapered surface 642 is provided on an end part on the (−Y) side of the stage 64 and adjacent to the cleaning plane 641 from the (−Y) side. The tapered surface 642 is an inclined surface descending toward the (−Y) side.

Further, a discharge plane 651 adjacent to the cleaning plane 641 from the (+Y) side in a plan view is provided on the upper surface of the base part 61. The discharge plane 651 is parallel to the cleaning plane 641 and located to be lower than the cleaning plane 641. A rising surface 652 is provided which rises from an end on the (−Y) side of the discharge plane 651 to an end on the (+Y) side of the cleaning plane 641. This rising surface 652 rises perpendicularly to the discharge plane 651. Further, in the Y direction, the position of an end on the (+Y) side of the discharge plane 651 coincides with the position of an end on the (+Y) side of the base part 61. That is, in the plan view, the discharge plane 651 is adjacent to the cleaning plane 641 in the cleaning direction Yc and recessed downward from the cleaning plane 641.

A contact plane 631, which overlaps a presence range Rc of the cleaning plane 641 in the Y direction, is provided on the upper surface of the side wall part 63. That is, in the Y direction, the position of an end on the (+Y) side of the cleaning plane 641 and the position of an end on the (+Y) side of the contact plane 631 coincide, and the position of an end on the (−Y) side of the cleaning plane 641 and the position of an end on the (−Y) side of the contact plane 631 coincide. The contact plane 631 is parallel to the cleaning plane 641 and located at the same height as the cleaning plane 641.

Further, a tapered surface 632 is provided on the upper surface of the side wall part 63. The tapered surface 632 is provided on an end part on the (−Y) side of the upper surface of the side wall part 63 and adjacent to the contact plane 631 from the (−Y) side. The tapered surface 632 is an inclined surface descending toward the (−Y) side. The tapered surface 632 has the same length in the Y direction as the tapered surface 642 and is inclined at the same angle.

Further, an extended surface 634, which is extended from the contact plane 631 further toward the discharge plane 651 (i.e. toward the (+Y) side) than the cleaning plane 641 in Y direction, is provided on the upper surface of the side wall part 63. In other words, the extended plane 634 projects toward the (+Y) side in the Y direction with respect to the cleaning plane 641. This extended surface 634 overlaps a presence range Re of the discharge plane 651 in the Y direction. That is, in the Y direction, the position of the end on the (+Y) side of the discharge plane 651 and the position of an end on the (+Y) side of the extended plane 634 coincide and the position of the end on the (−Y) side of the discharge plane 651 and the position of an end on the (−Y) side of the extended plane 634 coincide. The extended surface 634 includes a contacting extended plane 635 adjacent to the contact plane 631 from the (+Y) side and a tapered extended surface 636 adjacent to the contacting extended plane 635 from the (+Y) side. The contacting extended plane 635 is parallel to the contact plane 631 and located at the same height as the contact plane 631. That is, the contacting extended plane 635 and the contact plane 631 are flush with each other. The tapered extended surface 636 is an inclined surface descending toward the (+Y) side.

In such a maintenance member 6, the discharge plane 651 is located between a pair of the extended surfaces 634 located on both ends in the X direction. That is, in the plane view, the extended surface 634 is adjacent to the discharge plane 651 from the X direction. Further, the side wall part 63 has a rising surface 637 rising from the end of the discharge plane 651 to the end of the extended surface 634 in the Y direction. The rising surface 637 rises perpendicularly to the discharge plane 651. In this way, in the maintenance member 6, a recess C is provided which is defined by the discharge plane 651, a pair of the rising surfaces 637 rising from both ends in the X direction of the discharge plane 651 and the rising surface 652 rising from the end on the (−Y) side of the discharge plane 651, and the recess C is open on the (+Y) side (in other words, in the cleaning direction Yc).

Further, the maintenance member 6 includes a pair of grooves 66 provided on both sides of the stage 64 in the X direction. The groove 66 is provided between the stage 64 and the side wall part 63 in the X direction and recessed downward from each of the stage 64 and the side wall part 63. The groove 66 extends over the entire length of the stage 64 in the Y direction. The groove 66 is open on both ends in the Y direction, particularly open to the recess C at the end on the (+Y) side. That is, the pair of grooves 66 are open to both ends of the recess C (in other words, both ends of the discharge plane 651) in the X direction. Note that the bottom of the groove 66 is located above the discharge plane 651. However, the bottom of the groove 66 and the discharge plane 651 may be at the same height.

In cleaning the recording head H by the maintenance member 6, the maintenance member 6 contacts the recording head H while facing the recording head H from below (FIG. 3C). As shown in FIG. 3C, the recording head H has a pair of contact planes Hf located on both sides in the X direction of the nozzle opening plane Hp. The contact planes Hf project further downward than the nozzle opening plane Hp, i.e. the nozzle opening plane Hp is positioned higher than the contact planes Hf. These nozzle opening plane Hp and contact planes Hf face downward. On the other hand, the cleaning plane 641, the discharge plane 651 and the contact planes 631 of the maintenance member 6, which are arranged below the recording head H, face upward. The pair of contact planes 631 respectively come into contact with the pair of contact planes Hf from below. Further, the pair of grooves 66 respectively face the pair of contact planes Hf from below. Furthermore, the cleaning plane 641 faces the nozzle opening plane Hp from below, and the discharge plane 651 face the nozzle opening plane Hp from below.

In contrast, the cleaning liquid nozzles Nc and the suction nozzles Ns are open in the cleaning plane 641. The cleaning liquid nozzles Nc supply the cleaning liquid to a space S between the cleaning plane 641 and the nozzle opening plane Hp by discharging the cleaning liquid upward. Further, the suction nozzles Ns remove the cleaning liquid from the space S by sucking the cleaning liquid in the space S. In this way, the ink adhering to the nozzle opening plane Hp is washed away by the cleaning liquid. Further, the nozzle opening plane Hp is cleaned while the maintenance member 6 is moved in the cleaning direction Yc with respect to the recording head H.

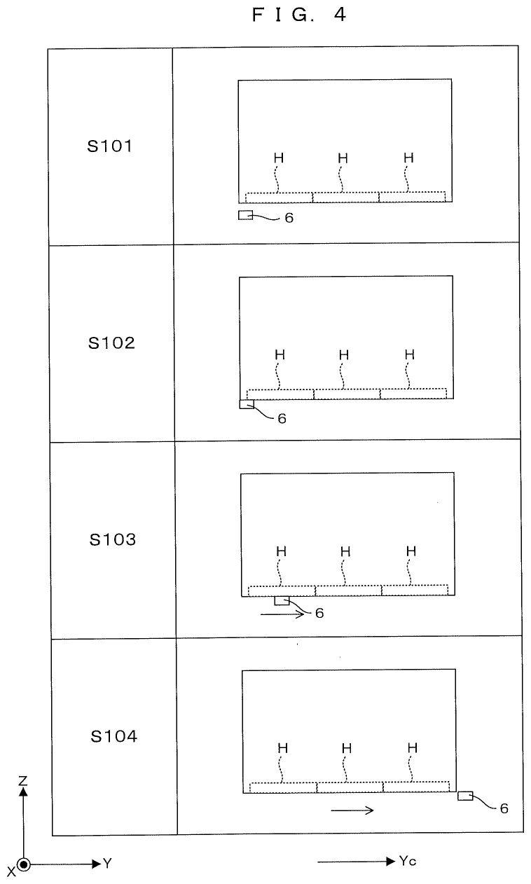

FIG. 4 shows diagrams schematically showing a recording head cleaning operation performed by the maintenance member, and FIG. 5 is a block diagram showing an electrical configuration for performing the cleaning operation of FIG. 4. As shown in FIG. 5, the printing apparatus 3 is provided with a controller 9. The controller 9 is a processor. Further, the printing apparatus 3 includes the Y-axis driver My, the Z-axis driver Mz, a cleaning liquid supplier 91, a cleaning liquid sucker 92 and a drainer 93. The Y-axis driver My, the Z-axis driver Mz, the cleaning liquid supplier 91, the cleaning liquid sucker 92 and the drainer 93 operate in accordance with a control of the controller 9.

The Y-axis driver My is a single-axis robot such as a ball screw or a linear motor and drives the maintenance unit 5 in the Y direction. Specifically, the base plate 51 of the maintenance unit 5 is coupled to a slider of the single-axis robot, and the maintenance unit 5 is driven in the Y direction by the Y-axis driver My driving the slider in the Y direction. The Z-axis driver Mz is, for example, an air cylinder and moves the maintenance member 6 upward and downward. The cleaning liquid supplier 91 includes a liquid feed pipe connected to the cleaning liquid supply port 56 and a liquid feed pump provided in the liquid feed pipe. The liquid feed pump of the cleaning liquid supplier 91 feeds the cleaning liquid to the cleaning liquid supply port 56 via the liquid feed pipe, whereby the cleaning liquid is discharged from the cleaning liquid nozzles Nc. The cleaning liquid sucker 92 includes a suction pipe connected to the cleaning liquid suction port 57 and a suction pump provided in the suction pipe. The suction pump of the cleaning liquid sucker 92 sucks the cleaning liquid suction port 57 via the suction pipe, whereby the cleaning liquid is sucked from the suction nozzles Ns. The drainer 93 includes a drainage pipe connected to the drainage port 534 and a drainage pump provided in the drainage pipe. The drainage pump of the drainer 93 sucks the drainage port 534 via the drainage pipe, whereby the cleaning liquid is discharged from the drainage tray 53.

In Step S101, the controller 9 causes the maintenance member 6 to face the recording head H on a most upstream side in the cleaning direction Yc, out of the plurality of recording heads H, from below by controlling the position in the Y direction of the maintenance member 6 by the Y-axis driver My. At this time, the controller 9 separates the maintenance member 6 downward from the recording head H by controlling the height of the maintenance member 6 by the Z-axis driver Mz.

In Step S102, the controller 9 brings the maintenance member 6 into contact with the recording head H from below by controlling the height of the maintenance member 6 by the Z-axis driver Mz. In this way, a state shown in FIG. 3C is set. Subsequently, the controller 9 causes the cleaning liquid supplier 91 to start the supply of the cleaning liquid. In this way, the cleaning liquid nozzles Nc discharge the cleaning liquid to the space S between the discharge plane 651 and the nozzle opening plane Hp (cleaning liquid supplying operation). Further, the controller 9 causes the cleaning liquid sucker 92 to start the suction of the cleaning liquid. In this way, the suction nozzles Ns suck the cleaning liquid from the space S (cleaning liquid sucking operation).

In Step S103, the controller 9 causes the Y-axis driver My to start the drive of the maintenance member 6. In this way, the maintenance member 6 moves in the cleaning direction Yc (moving operation). In this way, the maintenance member 6 cleans the nozzle opening plane Hp of the recording head H by performing the cleaning liquid supplying operation and the cleaning liquid sucking operation while moving with respect to the recording head H. Note that, if there is a step between the recording heads H adjacent in the cleaning direction Yc, the maintenance member 6 moves downward while the tapered extended surfaces 636 of the maintenance member 6 is brought into contact with the step. In this way, an impact generated between the maintenance member 6 and the step is mitigated. When the cleaning of all the recording heads H is completed (Step S104), the controller 9 stops the supply of the cleaning liquid from the cleaning liquid nozzles Nc, the suction of the cleaning liquid from the suction nozzles Ns and a movement of the maintenance member 6 in the cleaning direction Yc.

In the embodiment described above, the maintenance member 6 has the cleaning plane 641 (cleaning surface), in which the cleaning liquid nozzles Nc for discharging the cleaning liquid are open, and two contact planes 631 (maintenance contact surfaces), which are provided on the both sides in the X direction (width direction) of the cleaning plane 641. The cleaning liquid is supplied to the cleaning plane 641 from the cleaning liquid nozzles Nc (cleaning liquid supplying operation) by the cleaning liquid nozzles Nc discharging the cleaning liquid while the maintenance member 6 is moved with respect to the recording head H in the cleaning direction Yc (moving direction) with the contact planes 631 on the both sides of the cleaning plane 641 held in contact with the contact planes Hf (head contact surfaces) on the both sides of the nozzle opening plane Hp (nozzle surface) (moving operation). In contrast, the maintenance member 6 has the discharge plane 651 (discharge surface), which is adjacent to the cleaning plane 641 in the cleaning direction Yc and recessed downward from the cleaning plane 641. This discharge plane 651 is provided between the two extended surfaces 634, which are extended in the cleaning direction Yc respectively from the two contact planes 631, in the X direction. In such a configuration, a flow of the cleaning liquid falling down from the cleaning plane 641 to the discharge plane 651 in the cleaning direction Yc is formed. Thus, the amount of the cleaning liquid flowing in the X direction from the cleaning plane 641 can be suppressed. As a result, the adhesion of the ink to the contact planes Hf on the both sides of the nozzle opening plane Hp can be suppressed in cleaning the nozzle opening plane Hp of the recording head H with the cleaning liquid.

Further, the maintenance member 6 has two rising surfaces 637 (wall surfaces) respectively rising in parallel to the Z direction from the both ends of the discharge plane 651 in the X direction to the two extended surfaces 634. The recess C defined by the two rising surfaces 637 and the discharge plane 651 is open on the side ((+Y) side) opposite to the cleaning plane 641 in the cleaning direction Yc. In such a configuration, the spread of the cleaning liquid in the X direction can be suppressed by the rising surfaces 637 by discharging the cleaning liquid falling down to the discharge plane 651 equivalent to the bottom of the recess C toward the (+Y) side.

Further, the discharge plane 651 is provided downstream of the cleaning plane 641 in the cleaning direction Yc. In such a configuration, the spread of the cleaning liquid in the X direction can be suppressed on the downstream side in the cleaning direction Yc.

Further, the maintenance member 6 includes two grooves 66, each positioned between the respective contact planes 631 and the respective ends of the cleaning plane 641 along the X direction. Each of the two grooves 66 extends in the cleaning direction Yc and is open on the side of the discharge plane 651 (on the (+Y) side). In such a configuration, the cleaning liquid moving in the X direction from the cleaning plane 641 is guided in the cleaning direction Yc by the grooves 66 and any further spread of the cleaning liquid in the X direction can be suppressed.

Further, the cleaning liquid sucker 92 (cleaning liquid remover) is provided which removes the cleaning liquid from the cleaning plane 641. In contrast, the maintenance member 6 includes the suction nozzles Ns open in the cleaning plane 641. The cleaning liquid sucker 92 removes the cleaning liquid from the cleaning plane 641 by sucking the cleaning liquid from the suction nozzles Ns. In such a configuration, the spread of the cleaning liquid in the X direction can be suppressed by sucking the cleaning liquid from the cleaning plane 641 to the suction nozzles Ns.

Further, the suction nozzles Ns are provided on an upstream side ((−Y) side) of the cleaning liquid nozzles Nc in the cleaning direction Yc. That is, the cleaning liquid supplied to the cleaning plane 641 from the cleaning liquid nozzles Nc flows to the upstream side in the cleaning direction Yc with respect to the cleaning plane 641 as the cleaning plane 641 moves in the cleaning direction Yc. Therefore, the cleaning liquid can be efficiently removed from the cleaning plane 641 and the spread of the cleaning liquid in the X direction can be suppressed by providing the suction nozzles Ns on the upstream side of the cleaning liquid nozzles Nc in the cleaning direction Yc.

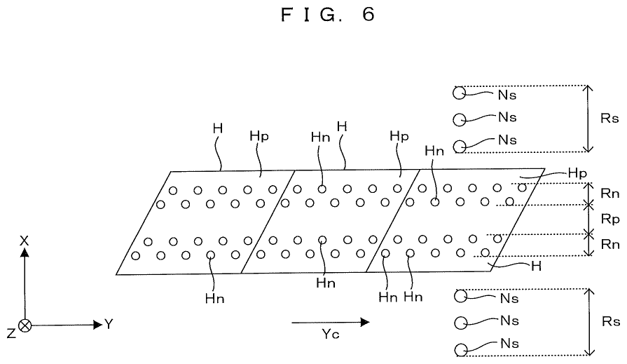

Further, the suction nozzles Ns are provided at positions not facing the ink nozzles Hn with the maintenance member 6 facing the recording head H from below (FIG. 6). FIG. 6 is a bottom view schematically showing a positional relationship of the ink nozzles Hn and the suction nozzles Ns. Particularly, the positional relationship in a situation where the maintenance member 6 is in contact with the recording head H from below as shown in FIG. 3C is shown in FIG. 6. That is, the positions of the respective suction nozzles Ns and those of the ink nozzles Hn deviate from each other in the X direction. In other words, a suction region Rs where the suction nozzles Ns are disposed and the nozzle arrangement regions Rn deviate from each other and do not overlap in the X direction. In such a configuration, the contamination of the nozzle opening plane Hp by the ink sucked out from the ink nozzles Hn by the suction nozzles Ns can be suppressed.

Further, the extended surface 634 has the tapered extended surface 63 (taper) descending toward the side ((+Y) side) opposite to the contact plane 631 on the end part on the side ((+Y) side) opposite to the contact plane 631 in the cleaning direction Yc. In such a configuration, it can be suppressed that the maintenance member 6 and the recording head H collide with and are caught by each other in the cleaning direction Yc.

Further, the drainage tray 53 (cleaning liquid discharge unit) is provided which is arranged below the maintenance member 6 and receives and discharges the cleaning liquid falling down from the discharge plane 651. In such a configuration, the cleaning liquid falling down from the cleaning plane 641 to the discharge plane 651 can be received by and discharged from the drainage tray 53.

As described above, in this embodiment, the ink nozzle Hn corresponds to an example of an “ink nozzle” of the disclosure, the nozzle opening plane Hp corresponds to an example of a “nozzle surface” of the disclosure, the X direction corresponds to an example of a “width direction” of the disclosure, the contact plane Hf corresponds to an example of a “head contact surface” of the disclosure, the recording head H corresponds to an example of a “recording head” of the disclosure, the cleaning liquid nozzle Nc corresponds to an example of a “cleaning liquid nozzle” of the disclosure, the cleaning plane 641 corresponds to an example of a “cleaning surface” of the disclosure, the contact plane 631 corresponds to an example of a “maintenance contact surface” of of the disclosure, the maintenance member 6 corresponds to an example of a “maintenance member” of the disclosure, the cleaning direction Yc corresponds to an example of a “moving direction” of the disclosure, the Y-axis driver My corresponds to an example of a “driver” of the disclosure, the cleaning liquid supplier 91 corresponds to an example of a “cleaning liquid supplier” of the disclosure, the discharge plane 651 corresponds to an example of a “discharge surface” of the disclosure, the extended surface 634 corresponds to an example of an “extended surface” of the disclosure, the printing apparatus 3 corresponds to an example of a “printing apparatus” of the disclosure, the rising surface 637 corresponds to an example of a “wall surface” of the disclosure, the recess C corresponds to an example of a “recess” of the disclosure, the groove 66 corresponds to an example of a “groove” of the disclosure, the cleaning liquid sucker 92 corresponds to an example of a “cleaning liquid remover” of the disclosure, the suction nozzle Ns corresponds to an example of a “suction nozzle” of the disclosure, the tapered extended surface 636 corresponds to an example of a “taper” of the disclosure, and the drainage tray 53 corresponds to an example of a “cleaning liquid drainage unit” of the disclosure.

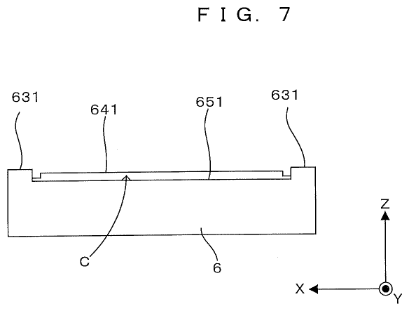

Note that the disclosure is not limited to the embodiment described above and various changes other than the aforementioned ones can be made without departing from the gist of the disclosure. For example, in the above embodiment, the cleaning plane 641 and the contact plane 631 are located at the same height. However, the positional relationship of these can be changed (FIG. 7). FIG. 7 is a diagram showing a modification of the positional relationship of the cleaning plane and the contact plane. In the modification of FIG. 7, the cleaning plane 641 (cleaning surface) is located to be lower than each of the two contact planes 631 (maintenance contact surfaces). In such a configuration, the wide space S (interval) is secured between the cleaning plane 641 and the nozzle opening plane Hp and the ink easily flows in this space S. As a result, the ink can be effectively washed away from the nozzle opening plane Hp.

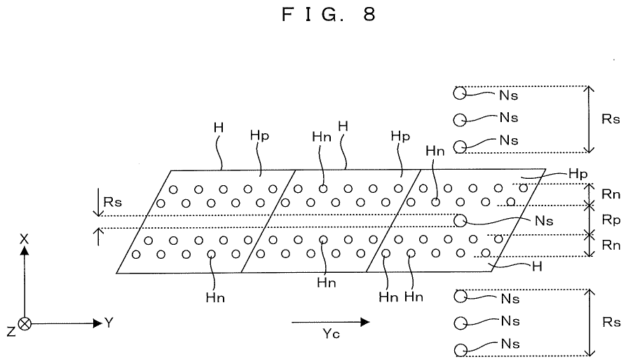

Further, an arrangement mode of the suction nozzles Ns may be changed as appropriate (FIG. 8). FIG. 8 is a diagram schematically showing a modification of the arrangement mode of the suction nozzles. Particularly in FIG. 8, a positional relationship in the situation where the maintenance member 6 is in contact with the recording head H from below as shown in FIG. 3C is shown. A difference from the example of FIG. 6 is that the suction nozzles Ns, which faces the nozzle non-arrangement region Rp provided between the two nozzle arrangement regions Rn in the X direction, are added.

That is, the nozzle opening plane Hp (nozzle surface) includes the two nozzle arrangement regions Rn respectively extending in the cleaning direction Yc and the nozzle non-arrangement region Rp provided between the two nozzle arrangement regions Rn in the X direction. The ink nozzles Hn are provided in each of the two nozzle arrangement regions Rn, but the ink nozzles Hn are not provided in the nozzle non-arrangement region Rp. The plurality of suction nozzles Ns include the suction nozzle Ns facing the nozzle non-arrangement region Rp. That is, this suction nozzle Ns faces the nozzle non-arrangement region Rp with the maintenance member 6 facing the recording head H from below. In such a configuration, the suction nozzle Ns can be provided in proximity to the ink nozzles Hn while deviating from the ink nozzles Hn. As a result, the ink adhering around the ink nozzles Hn can be removed by the suction nozzle Ns.

Further, the discharge plane 651 may be provided not on the (+Y) side, but on the (−Y) side of the cleaning plane 641.

### INDUSTRIAL APPLICABILITY

The disclosure is applicable to techniques in general for cleaning a recording head for discharging an ink from an ink nozzle.

The printing apparatus may be configured so that the maintenance member has two wall surfaces respectively rising from both ends of the discharge surface in the width direction to the two extended surfaces, and a recess defined by the two wall surfaces and the discharge surface is open on a side opposite to the cleaning surface in the moving direction. In such a configuration, the spread of the cleaning liquid falling down to the discharge surface equivalent to the bottom of the recess in the width direction can be suppressed by the wall surfaces.

The printing apparatus may be configured so that the discharge surface is provided downstream of the cleaning surface in the moving direction. In such a configuration, the spread of the cleaning liquid in the width direction can be suppressed on a downstream side in the moving direction.

The printing apparatus may be configured so that the maintenance member includes two grooves, each positioned between respective maintenance contact surfaces and respective ends of the cleaning surface along the width direction, and each of the two grooves extends in the moving direction and is open on the discharge surface side. In such a configuration, the cleaning liquid moving in the width direction from the cleaning surface can be guided in the moving direction by the grooves and any further spread of the cleaning liquid in the width direction can be suppressed.

The printing apparatus may further comprise a cleaning liquid remover removing the cleaning liquid from the cleaning surface, wherein: the maintenance member includes a suction nozzle open in the cleaning surface, and the cleaning liquid remover removes the cleaning liquid from the cleaning surface by sucking the cleaning liquid by the suction nozzle. In such a configuration, the spread of the cleaning liquid in the width direction can be suppressed by causing the suction nozzle to suck the cleaning liquid from the cleaning surface.

The printing apparatus may be configured so that the suction nozzle is provided upstream of the cleaning liquid nozzle in the moving direction. That is, the cleaning liquid supplied from the cleaning liquid nozzle to the cleaning surface flows to an upstream side in the moving direction with respect to the cleaning surface as the cleaning surface moves in the moving direction. Therefore, the cleaning liquid can be efficiently removed from the cleaning surface and the spread of the cleaning liquid in the width direction can be suppressed by providing the suction nozzle on the side upstream of the cleaning liquid nozzle in the moving direction.

The printing apparatus may be configured so that the suction nozzle is provided at a position not facing the ink nozzle with the maintenance member facing the recording head from below. In such a configuration, the contamination of the nozzle surface by the ink sucked from the ink nozzle by the suction nozzle can be suppressed.

The printing apparatus may be configured so that the nozzle surface includes two nozzle arrangement regions respectively extending in the moving direction and a nozzle non-arrangement region provided between the two nozzle arrangement regions in the width direction, the ink nozzle is provided in each of the two nozzle arrangement regions, no ink nozzle is provided in the nozzle non-arrangement region, and the suction nozzle faces the nozzle non-arrangement region with the maintenance member facing the recording head from below. In such a configuration, the suction nozzle can be provided in proximity to the ink nozzle while deviating from the ink nozzle. As a result, the ink adhering around the ink nozzle can be removed by the suction nozzle.

The printing apparatus may be configured so that the cleaning surface is located to be lower than each of the two maintenance contact surfaces. In such a configuration, a wide interval is ensured between the cleaning surface and the nozzle surface and the ink easily flows in this interval. As a result, the ink can be effectively washed away from the nozzle surface.

The printing apparatus may be configured so that the extended surface has a taper descending toward a side opposite to the maintenance contact surface on an end part opposite to the maintenance contact surface in the moving direction. In such a configuration, it can be suppressed that the maintenance member and the recording head collide with and are caught by each other in the moving direction.

The printing apparatus may further comprises a cleaning liquid discharge unit arranged below the maintenance member for receiving and discharging the cleaning liquid falling down from the discharge surface. In such a configuration, the cleaning liquid falling down from the cleaning surface to the discharge surface can be received by and discharged from the cleaning liquid discharge unit.

Although the disclosure has been described with reference to specific embodiments, this description is not meant to be construed in a limiting sense. Various modifications of the disclosed embodiment, as well as other embodiments of the present disclosure, will become apparent to persons skilled in the art upon reference to the description of the disclosure. It is therefore contemplated that the appended claims will cover any such modifications or embodiments as fall within the true scope of the disclosure.

What is claimed is:

1. A printing apparatus, comprising:
a recording head having a nozzle surface, an ink nozzle for discharging an ink being open in the nozzle surface, and two head contact surfaces provided on both sides in a width direction of the nozzle surface and located below the nozzle surface;
a maintenance member having a cleaning surface, a cleaning liquid nozzle for discharging a cleaning liquid being open in the cleaning surface, and two maintenance contact surfaces provided on both sides in the width direction of the cleaning surface;
a driver configured to perform a moving operation of relatively moving the maintenance member with respect to the recording head in a moving direction orthogonal to the width direction with the maintenance member caused to face the recording head from below and the two maintenance contact surfaces respectively held in contact with the two head contact surfaces; and
a cleaning liquid supplier configured to perform a cleaning liquid supplying operation of supplying the cleaning liquid to the cleaning surface from the cleaning liquid nozzle by causing the cleaning liquid nozzle to discharge the cleaning liquid,
the cleaning liquid supplier performing the cleaning liquid supplying operation in parallel with the moving operation by the driver,
the maintenance member having a discharge surface, which is adjacent to the cleaning surface in the moving direction and recessed downward from the cleaning surface, and two extended surfaces, which are extended further toward the discharge surface than the cleaning surface respectively from the two maintenance contact surfaces in the moving direction, and
the discharge surface being located between the two extended surfaces in the width direction.

2. The printing apparatus according to claim 1, wherein:
the maintenance member has two wall surfaces respectively rising from both ends of the discharge surface in the width direction to the two extended surfaces, and
a recess defined by the two wall surfaces and the discharge surface is open on a side opposite to the cleaning surface in the moving direction.

3. The printing apparatus according to claim 1, wherein:
the discharge surface is provided downstream of the cleaning surface in the moving direction.

4. The printing apparatus according to claim 1, wherein:
the maintenance member includes two grooves, each positioned between respective maintenance contact surfaces and respective ends of the cleaning surface along the width direction, and
each of the two grooves extends in the moving direction and is open on the discharge surface side.

5. The printing apparatus according to claim 1, further comprising a cleaning liquid remover removing the cleaning liquid from the cleaning surface, wherein:
the maintenance member includes a suction nozzle open in the cleaning surface, and
the cleaning liquid remover removes the cleaning liquid from the cleaning surface by sucking the cleaning liquid by the suction nozzle.

6. The printing apparatus according to claim 5, wherein:
the suction nozzle is provided upstream of the cleaning liquid nozzle in the moving direction.

7. The printing apparatus according to claim 5, wherein:
the suction nozzle is provided at a position not facing the ink nozzle with the maintenance member facing the recording head from below.

8. The printing apparatus according to claim 7, wherein:
the nozzle surface includes two nozzle arrangement regions respectively extending in the moving direction and a nozzle non-arrangement region provided between the two nozzle arrangement regions in the width direction,
the ink nozzle is provided in each of the two nozzle arrangement regions,
no ink nozzle is provided in the nozzle non-arrangement region, and
the suction nozzle faces the nozzle non-arrangement region with the maintenance member facing the recording head from below.

9. The printing apparatus according to claim 1, wherein:
the cleaning surface is located to be lower than each of the two maintenance contact surfaces.

10. The printing apparatus according to claim 1, wherein:
the extended surface has a taper descending toward a side opposite to the maintenance contact surface on an end part opposite to the maintenance contact surface in the moving direction.

11. The printing apparatus according to claim 1, further comprising a cleaning liquid discharge unit arranged below the maintenance member for receiving and discharging the cleaning liquid falling down from the discharge surface.

12. A recording head cleaning method, comprising:
performing a moving operation of relatively moving a maintenance member with respect to a recording head in a moving direction with the maintenance member held in contact with the recording head from below; and
performing a cleaning liquid supplying operation of supplying a cleaning liquid to between the maintenance member and the recording head,
the recording head having a nozzle surface, an ink nozzle for discharging an ink being open in the nozzle surface, and two head contact surfaces provided on both sides of the nozzle surface in a width direction orthogonal to the moving direction and located below the nozzle surface,
the maintenance member having a cleaning surface, a cleaning liquid nozzle for discharging a cleaning liquid being open in the cleaning surface, and two maintenance contact surfaces provided on both sides in the width direction of the cleaning surface;
the maintenance member being relatively moved with respect to the recording head in the moving direction with the maintenance member facing the recording head from below and the two maintenance contact surfaces respectively held in contact with the two head contact surfaces in the moving operation,
the cleaning liquid being supplied from the cleaning liquid nozzle to the cleaning surface by the cleaning liquid nozzle discharging the cleaning liquid in the cleaning liquid supplying operation,
the maintenance member having a discharge surface adjacent to the cleaning surface in the moving direction and recessed downward from the cleaning surface and two extended surfaces extended further toward the discharge surface than the cleaning surface respectively from the two maintenance contact surfaces in the moving direction, and
the discharge surface being located between the two extended surfaces in the width direction.
